(19) United States
(12) Patent Application Publication
(10) Pub. No.: US 2004/0024756 A1
(43) Pub. Date: Feb. 5, 2004

(54) Search engine for non-textual data

(76) Inventor: John Terrell Rickard, Durango, CO (US)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/389,421

(22) Filed: Mar. 14, 2003

Related U.S. Application Data
(60) Provisional application No. 60/401,129, filed on Aug. 5, 2002.

(51) Int. Cl. G06F 17/30

(52) U.S. Cl. 707/3

(57) ABSTRACT

A non-textual data searching system according to the invention is capable of searching non-textual data at semantic levels above the fundamental symbolic level. The general approach begins by indexing the non-textual data corpus in such a way as to facilitate searching. The indexing process results in a number of “keytroids” that represent clusters of fuzzy attribute vectors, where each fuzzy attribute vector represents a data event associated with one or more non-textual data points. The actual searching process is analogous to a conventional text-based search engine: a query vector, which identifies a number of fuzzy attributes of the desired data, is processed to retrieve and rank a number of keytroids. The keytroids can be inverse-mapped to obtain data events and/or non-textual data points that satisfy the query.

### CROSS REFERENCE TO RELATED APPLICATIONS

This application claims priority of U.S. provisional application serial No. 60/401,129, the content of which is incorporated by reference herein. The subject matter disclosed herein is related to the subject matter contained in U.S. patent application Ser. No. ______, titled DATA SEARCH SYSTEM AND METHOD USING MUTUAL SUBSETHOOD MEASURES, and U.S. patent application Ser. No. ______, titled SYSTEM AND METHOD FOR INDEXING NON-TEXTUAL DATA, both filed concurrently herewith.

### FIELD OF THE INVENTION

The present invention relates generally to data search engine technology. More particularly, the present invention relates to a search engine for non-textual data.

### BACKGROUND OF THE INVENTION

The prior art is replete with text-based search engines, algorithms, and procedures. Internet users are familiar with such text-based search engines, which are designed to enable quick retrieval of web pages, documents, and files of interest to the user. Conventional text-based search engines retrieve textual information in response to keyword queries. To accomplish this goal, the corpus of textual data is indexed to establish a persistent set of links between a relatively small database of keywords that characterize the contents of the corpus, and the actual locations within documents where the keywords (or variations thereof) occur.

A large number of systems gather, collect, store, and process different types of non-textual data. Such non-textual data encompasses broad categories of electronic data, such as sensor data (both signals and imagery), transaction data from markets and financial institutions, numerical data contained in business and government records, geographically referenced databases characterizing the surface and atmosphere of the earth, and the like. An inquiring user may be interested in the valuable contextual information buried within this vast ocean of non-textual data. Non-textual data, however, is numerical data having no immediate textual correspondence that lends itself to traditional text-based search techniques. Non-textual data has no natural query language and, therefore, traditional keyword-based methods are ineffective for non-textual searching.

For the above reasons, conventional methods for accessing and exploiting non-textual data tend to utilize straightforward database retrieval operations, manual keyword labeling of the data to enable retrieval via conventional search engines, or real-time forward processing approaches that “push” processed results at a human user, with limited provision of tools that enable a more retrospective style of information retrieval.

### BRIEF SUMMARY OF THE INVENTION

A non-textual data search engine can be utilized to retrieve information from a non-textual data corpus. The search engine retrieves the non-textual data based upon queries directed to data “descriptors” corresponding to a level above the abstract, symbolic, or raw data level. In this regard, the search engine enables a user to search for non-textual data at a relatively higher contextual level having more practical significance or meaning. The non-textual data search engine may leverage the general framework utilized by existing textual data search engines: the non-textual data corpus is indexed using “keytroids” that represent higher level attributes; the indexed non-textual data can then be searched using one or more keytroids; the retrieved non-textual data is ranked for relevance; and the system may be updated in response to user relevance feedback.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a flow diagram of a non-textual data indexing process;

FIG. 2 is a schematic representation of components of a non-textual data search system, where the components are configured to support the indexing process depicted in FIG. 1;

FIG. 3 is a diagram that illustrates a mapping operation between a non-textual data event corpus and a fuzzy attribute vector corpus;

FIG. 4 is a diagram that illustrates the construction of a keytroid index database;

FIG. 5 is a diagram that graphically depicts the manner in which “overlapping” clusters can share cluster members;

FIG. 6 is a diagram that depicts two-dimensional fuzzy sets;

FIG. 7 is a diagram that depicts components of fuzzy subsethood;

FIG. 8 is a geometric interpretation of mutual subsethood as a ratio of Hamming norms;

FIG. 9 is a schematic representation of an example non-textual data search system;

FIG. 10 is a flow diagram of an example non-textual data search process;

FIG. 11 is a schematic depiction of a connectionist architecture between keytroids and attribute events; and

FIG. 12 is a flow diagram of a generalized non-textual data searching approach.

### DETAILED DESCRIPTION OF A PREFERRED EMBODIMENT

The present invention may be described herein in terms of functional block components and various processing steps. It should be appreciated that such functional blocks may be realized by any number of software, firmware, or hardware components configured to perform the specified functions. For example, the present invention may employ or be embodied in computer programs, memory elements, databases, look-up tables, and the like, which may carry out a variety of functions under the control of one or more microprocessors or other control devices. In addition, those skilled in the art will appreciate that the concepts described herein may be practiced in conjunction with any type, classification, or category of non-textual data and that the examples described herein are not intended to restrict the application of the invention.

It should be appreciated that the particular implementations shown and described herein are illustrative of the invention and its best mode and are not intended to otherwise limit the scope of the invention in any way. Indeed, for the sake of brevity, conventional aspects of fuzzy set theory, clustering algorithms, similarity measurement, database management, computer programming, and other features of the non-textual search system (and the individual components of the system) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

In practice, the non-textual data search system is preferably implemented on a suitably configured computer system, a computer network, or any computing device, and a number of the processes carried out by the non-textual data search system are embodied in computer-executable instructions or program code. Accordingly, the following description of the non-textual data search system merely refers to processing “components” or “elements” that can represent computer-based processing or software modules and need not represent physical hardware components. In one embodiment, the non-textual data search system may be implemented on a stand-alone personal computer having suitable processing power, data storage capacity, and memory. Alternatively, the non-textual data search system may be implemented on a suitably configured personal computer having connectivity to the Internet or to another network database. Of course, the system may be implemented in the context of a local area network, a wide area network, one or more portable computers, one or more personal digital assistants, one or more wireless telephones or pagers having computing capabilities, a distributed computing platform, and any number of alternative computing configurations, and the invention is not limited to any specific realization.

In practical embodiments, the non-textual data search systems are configured to run computer programs having computer-executable instructions for carrying out the various processes described below. The computer programs may be written in any suitable program language, and the computer-executable code may be realized in any format compatible with conventional computer systems. For example, the computer programs may be written onto any of the following currently available tangible media formats: CD-ROM; DVD-ROM; magnetic tape; magnetic hard disk; or magnetic floppy disk. Alternatively, the computer programs may be downloaded from a remote site or server directly to the storage of the computer or computers that maintain the non-textual data search system. In this regard, the manner in which the computer programs are made available to the non-textual data search system is unimportant.

1.0—Introduction.

In modern society, there exists a virtually unlimited capacity to collect and store data throughout the multitudinous electronic infrastructure nodes and portals that underpin the economy, and within the numerous data collection systems of national defense and intelligence agencies. Much of this data is non-textual in nature, encompassing broad categories of digital data that include sensor data of various types (both signals and imagery, including audio and video), transaction data from markets and financial institutions, numerical data contained in business and government records, geographically referenced databases characterizing the earth's surface and atmosphere, to name just a few examples.

Buried within this vast ocean of data is valuable information and relationships that an inquiring user would like to discover. However, the retrieval of such information at a semantically significant level (i.e., beyond straightforward database retrieval operations) is a complex problem that requires fundamentally new technical approaches. The techniques described herein provide an approach to the extraction of information from diverse non-textual data sources and databases.

As used herein, “non-textual data” means numerical data that has no immediate textual or semantic correspondence that lends itself to text-based search methods. For example, a database of telephone calls has certain fields (e.g., area code and prefix) that obviously have an immediate textual correspondence to the names of the calling or receiving locales. However, the time of day and duration of the calls may have no simple and adequate correspondence to verbal descriptors for the purposes at hand.

Non-textual data is more difficult to “find out about” than textual data, for a number of reasons. For instance, unlike most textual data published in a database (e.g., a web server), non-textual data has no implicit desire to be discovered. Authors of archived textual documents presumably desire that others read their documents, and therefore cooperate in facilitating the functionality of textual search engines and ontologies. In addition, non-textual data has no natural query language to provide the “keywords” that lie at the heart of textual search engines. In this regard, there may exist no well-developed grammatical, semantic or ontological principles for many types of non-textual data, such as those that exist for textual information. For these and other reasons, the conventional methods of accessing and exploiting non-textual data tend to focus either on straightforward database retrieval operations, manual keyword labeling of the data to enable retrieval via conventional search engines, or real-time forward-processing approaches that “push” processed results at a human user, with limited provision of tools to enable a more retrospective style of information retrieval.

Consider an example scenario where the following databases are available, some of which are dynamically updated as real-time data is collected, while others represent static data: (1) a database of emitter “hits” from a sensor onboard an aircraft or satellite, each hit consisting of multiple parameters characterizing the emitter signal, location and time of receipt; (2) a database of digital terrain elevation data for the area in which the emitter is operating, which might also include other terrain features such as surface temperature, reflectivity, and the like; and (3) a map database describing roads and other man-made features relevant to the operation of the emitter.

Now consider example queries that a user may wish to make of these databases, such as the following: (1) find recent similar emitter hits; (2) find recent similar emitter hits close to a given geographic point that are on or near a given road segment; (3) find recent similar emitter hits that are nearly coincident in time with other nearby emitter hits or other observables. Terms such as “recent,” “similar,” “close,” and “nearly coincident,” are natural descriptors for a user desiring to search a database, but they may invoke an arduous construction of a large set of relational database queries, accompanied by a substantial amount of on-the-fly processing, for a user to perform such queries.

The challenge is to provide a search capability for non-textual databases that offers similar facility to that available with modern search engines for textual databases. This differs from conventional database retrieval in the following respect. In database retrieval, the user defines precisely what data is sought, and then retrieves it directly from the corresponding database fields. In many applications, however, the user may have no general idea of what data is present in the database, but rather desires to search for potential database entries that may be only approximate matches to sometimes vague queries, which may be serially refined upon examining the results of previous queries.

Finding out about non-text data employs some analogous constructs to those used in search engines for textual data, but requires a more numerical processing mindset and capabilities. The universe of discourse is parametric rather than linguistic. Queries are algorithmic and/or fuzzy. The grammatical, semantic, and ontological principles typically emerge from the physics of the domain, and/or from interaction with expert analysts and operators. Understanding how to forward-process numerical data for real-time applications provides a good foundation for the indexing of such data that is important to the construction of a search engine for these databases.

2.0—Information.

The desired information consists of combinations and/or correlations of data items from multiple data corpora that provide significant associations, indications, predictions, and/or conclusions about activities of interest. While easy to state, this description is not very constructive. In order better to understand the task at hand, the following is an analogy to the structure of information contained in a textual document corpus.

2.1—Text Information Levels.

At the most basic “symbolic” level, text documents may be viewed as streams of symbols drawn from an alphabet, i.e., letters, numbers, spaces, and punctuation symbols. One step up, the “lexical” level groups these symbols into the words of a language, which together make up the vocabulary available to construct sentences. Note the substantial reduction in the dimension of the space of possibilities imposed by lexical constraints—for example, there are 26⁴=456,976 possible four-letter combinations of the English alphabet, a number that approximates the total of all words in the English vocabulary, and greatly exceeds the actual number of four-letter words.

The “syntactic” level of information resides at the point of application of the rules of grammar and structure, which are used in assembling words into sentences that express the basic ideas, descriptions, assertions, and explanations, contained in a document. Syntactic constraints on coherent word combinations, phrases, and sentences induce a further substantial dimensionality reduction in the total space of possible word combinations.

Finally, at the “semantic” level of information, we seek the meaning to be derived from individual documents within a corpus, from a particular corpus as a whole, and more generally, from multiple corpora that may be unconnected physically or electronically. Meaning is extracted, clarified, and enhanced by contemplating the totality of facts and commentary on topics of interest across the corpora, and by comparing the similarities and differences of perspective among different contributors. Textual documents also typically contain figures, tables, graphs, pictures, bibliographies, references, links, attachment files, and other components that contribute to the semantic interpretation, over and above the actual text. While the dimensionality of the space of meaning is not well defined, to the extent that meaning interpretations dictate situational assessments and/or courses of actions, the latter represent a space of relatively small dimensionality compared to the syntactic space from which they are derived.

2.2—Non-Textual Information.

Now consider the corresponding components of non-textual corpora. The “symbolic” information in a non-textual corpus represents the input raw data collected by various sensing and/or recording systems, which may be, for example, time series samples, pixel values from an imaging sensor, or even transform coefficients and/or filter outputs that are computed from blocks of such data, but without a substantial reduction of the input data rate. In the latter case, the input data has been transformed from one large dimensional space to another space of comparable dimension. Further examples of raw data include financial records, transaction records, entry/exit records, transport manifests, government records of numerous types, and other numerical and/or activity information from relevant databases. This corpus of raw data is drawn from an enormous alphabet of numbers, letters, and other symbols, and in real-time applications, its size typically grows at least linearly with time.

The “lexical” information represents basic events, clusters, or classes that can be computed algorithmically from the raw input data, which operations typically induce a substantial reduction in output dimensionality compared to that of the input data. This level corresponds to output results from operations such as thresholding, clustering, feature extraction, classification, and data association algorithm outputs. Associated with each lexical component will be a set of attributes and/or parameter values having the analogous significance of “keywords” in a textual corpus. However, there generally will be no efficient mapping of these parametric lexical descriptions to keyword labels, since most or all of the lexical significance lies in the associated multi-dimensional distribution of numerical attribute and/or parameter values.

“Syntactic” information is developed from this lexical information through the algorithmic application of probabilistic or kinematical correlations and physical constraints over time, space, and other relevant dimensions within the domain of interest. For examples, a tracking algorithm may assemble groups of measurements collected over time into spatial track estimates, along with accompanying uncertainty estimates, using laws of motion and error propagation. An image interpretation algorithm may use multi-spectral imagery to estimate the number and type of vehicles whose engines have been running during the past hour, using thermodynamic and optical properties and pattern recognition algorithms. An expert system or case based reasoning system may combine multiple pieces of evidence to diagnose a disease condition using physician-derived rules, facts and databases of past case studies.

Finally, we have the “semantic” level of information, which seeks the meaning contained in these lower levels of information. Meanings of interest include situational assessments, indications and warnings, predictions, understanding, and decisions regarding beliefs or desired courses of actions. In some instances, these meanings may be extracted via computerized logical inference systems. More often, they will result from human interactions with displays of lower level information, where the final meaning is ascribed by a human operator/analyst. Table 1 compares the information levels of textual and non-textual data.

TABLE 1
Comparison of Information Levels Between
Textual and Non-Textual Data

| | TEXT | NON-TEXT |
|---|---|---|
| SYMBOLIC | letters, numbers, characters | raw data: time samples, |
| | making up the alphabet | pixels, transform co- |
| | | efficients, etc. |
| LEXICAL | words and all their | threshold events, clusters, |
| | variations about root forms | classes |
| SYNTACTIC | grammatical rules, phrase | probabilistic or kinematical |
| | and sentence structure | correlations, physical con- |
| | | straints over space, time, or |
| | | other relevant dimensions |
| SEMANTIC | meaning, perspective, | situational assessment, indi- |
| | understanding, decisions | cations and warnings, pre- |
| | regarding beliefs or actions | dictions understanding, |
| | | decisions regarding beliefs |
| | | or actions |

2.3—Information Measures.

Shannon's theory of communication addresses the statistical aspects of information, focusing on the symbolic level, but incorporating statistical implications from the lexical and, to a lesser degree, syntactic levels. Shannon's theory is concerned essentially with quantifying the statistical behavior of symbol strings, along with the corresponding implications for encoding such strings for transmission through noisy channels, compressing them for minimal distortion, encrypting them for maximum security, and so on. The fundamental measures employed in Shannon's theory are entropy and mutual information, which are readily computable in many instances from probabilistic models of sources and channels. Because it ultimately deals only with operations on symbols, Shannon's theory has enjoyed a great deal of practical success in applications lying within this domain, but it sheds no further light on the description of higher levels of information.

The algorithmic information complexity (“AIC”) concept adds a computational component to Shannon's statistical characterization of information, namely the minimal program length required to represent a symbol string. This approach imputes higher information content to individual strings and collections of strings that exhibit more “randomness,” in the sense that they require greater minimum program lengths. AIC adds considerably to the characterization of information by prescribing a measure for the information content of regularities and/or realizations that cannot be accounted for statistically.

For example, the output of a binary pseudo-random number generator may pass every conceivable statistical test for randomness, leading one to conclude on this basis that it is indistinguishable from a truly random binary source having an entropy rate of one bit/symbol for all output sequences. However, given the seed, initial value and algorithm description (all entities of finite length), its output sequences of arbitrary length are in fact entirely deterministic, leading to the opposite extreme conclusion that its asymptotic entropy rate is zero. In practice, however, AIC has proven less amenable to practical applications because of the frequent intractability of calculating and manipulating the underlying complexity measure.

These two perspectives have been combined into a “total information” measure representing the sum of an algorithmic information measure and a Shannon-type information measure. The first measure relates to the effective complexity of patterns and/or relationships that remain, once the effects of randomness have been set aside, while the second term relates to the degree that random effects impose deviations upon these patterns. The effective complexity is measured in terms of the minimal representations (denoted as “schemata”) required to describe the patterns and/or relationships.

For example, the target motion models used in a tracking algorithm increase in effective complexity, going from simple straight-line motion models to those that admit more complex target maneuvers and/or constraints based upon terrain or road infrastructure knowledge. This increase in the complexity of the problem is quite independent of the probabilistic aspects of the measurements input to the tracker, and thus the tracking algorithm requires additional information inputs, as well as processing of a non-statistical nature, in order to perform acceptably.

2.4—Semantic Information Requirements.

Unfortunately, none of the above theories adequately characterizes semantic information, which ultimately is the most important realm of interest. Indeed, there is not even general agreement on the relationship between semantic information and syntactic information, even for textual data, much less so for non-textual data. Part of the problem is that semantic information is often a combination of event-induced or physical information with agent-induced or conceptual information. The former arises from physical-world processes and regularities (e.g., the state vector resulting from the control signals applied to an aircraft in flight), while the latter arises from the actions of an intelligent agent (e.g., the intentions of the pilot in setting these control signals). In the first case, there is some hope of algorithmically extracting semantically meaningful information (e.g., “this aircraft is not executing its anticipated flight plan”), while in the second case, it will generally require the intelligent agency of another human's intuition to infer the semantic significance of the first agent's actions (e.g., “this aircraft apparently has been hijacked, and poses an imminent danger to the following potential targets . . . ”).

The above considerations lead one to address both types of semantic information in non-textual data domains, i.e., both physical and conceptual. Of these two, physical semantic information is by far the easier to deal with in a forward-processing sense, to the degree that we can algorithmically extract, correlate, integrate and logically infer semantic information from the lexical and syntactic information within a domain of interest. Even this task, however, requires extensive domain expertise, access to relevant databases and/or data feeds, knowledge of the complement of algorithmic and inference technologies, capabilities in sophisticated software implementation and system development, and ultimately, interpretation and validation of the results by a reasonably skilled human operator. These are the prerequisites to building an automated forward processing system that can alert the user to physical semantic information.

But what of the conceptual semantic information and residual physical information that forward processing systems are incapable of extracting, either in principle or due to their inevitable incompleteness and/or inadequacy of design to meet all possible circumstances? As distasteful as it may be to admit, there is no total automated software solution to such problems. Rather, we are forced to rely upon the intelligent agency of human analysts as a component of the solution, else we face the prospect of valuable semantic information going undetected within the data corpora of interest.

Once this reality is acknowledged, the problem then becomes one of facilitating the capabilities of human analysts with software tools that enable them to retrieve the information needed to formulate and test semantic conjectures. Unlike traditional database technologies, which provide specific information relative to a specific query, the ubiquitous tool used in textual information extraction is the “search engine,” which in various well-known embodiments facilitates keyword (i.e., lexical) and more advanced syntactic searches including Boolean combinations and exclusions, attribute restrictions, and similarity and or link restrictions. Search engines enable queries of document corpora in which the user frequently has only a vague notion of what he is looking to find. More importantly, they engage the user in an interactive dialog, incorporating his relevance feedback and intuition into the process of information retrieval.

The techniques described below represent an analogous approach to non-textual information retrieval, i.e., a search engine whose indexing and query structure is based not upon keywords, but upon non-textual lexical and syntactic information appropriate to the particular domain of interest. As a prelude, it is appropriate to review the functionality of textual search engines.

3.0—Text Search Engine Functionality.

The development of search engine technology for textual corpora has progressed steadily over the past few decades, although it is interesting to note that the first commercial Internet search engine only became available as late as 1995. At the macro level, search engines typically perform three high level functions: (1) indexing of the data corpora to be searched; (2) weighting and matching against corpora documents to facilitate retrieval; and (3) incorporating relevance feedback from a user to refine subsequent queries. The following description briefly reviews these functions.

3.1—Indexing the Data Corpora.

In order feasibly to search a large data corpus without having to perform an exhaustive search for each query, it is necessary to index a data corpus. The index function establishes a persistent set of links between a much smaller database of keywords that characterize the contents of the corpus, and the actual locations within documents where these words (or variations of them) occur.

If one imagines a large data corpus as nothing more than an enormously long string of words (i.e., a lexical perspective), the first operation in constructing an index is to scan through the entire string and “stem” each word occurrence, i.e., convert each variation of a word to its corresponding root form. Thus, a word such as “women” is reduced to the root form “woman.” Simultaneously, all “noise words,” including articles and prepositions such as “if,” “and,” “but,” and “the,” which have no implicit information content, are discarded from the string. The remaining keyword candidates are then posted to a data file that compiles the incidence of each word, along with pointers to the document locations in which it occurs.

From the posting file, one computes frequency of occurrence statistics for each keyword, both within a given document and within the corpus as a whole. The word occurrence frequencies for the corpus as a whole are ranked in descending order, with the highest frequency having rank one, and lower frequencies having respectively lower ranks. It has been empirically observed that, over a large ensemble of data corpora of different types, the distribution of word frequency versus rank obeys Zipf's law, or a slight generalization thereof proposed by Mandelbrot:

$$F ( r ) = \frac{C}{{( r + b )}^{α}} \qquad ( 1 )$$

where α is a constant very nearly equal to unity, r is the word rank, and b and C are translation and scaling constants, respectively. It turns out that this expression can be derived from a simple probabilistic model of randomly generated lexicographic trees. Thus the actual occurrence frequencies of all words in the posting file are roughly inversely proportional to the rank of their frequency of occurrence.

At this point, it might be tempting to adopt the contents of the posting file as the keyword index database, given that it contains all non-noise words from the corpora in root form, with pointers to their locations. However, since the task is to provide a generic search capability for a large ensemble of users, the indexing function goes one step further, and eliminates both the lowest ranked (most frequently occurring) and highest ranked (least frequently occurring) words from the posting file. The former are eliminated because their use as keywords would result in the recall of too large a fraction of the total documents in the corpora, resulting in inadequate search precision. The latter are eliminated because they are so rare and esoteric as to be of little utility for the purposes of general search of a corpus. The remaining, middle-ranked set of keywords (typically numbering in the low tens of thousands of words) then becomes the index database.

Note that for a static data corpus, indexing is nominally a one-time operation. However, most corpora grow over time, and thus the indexing function must be continually updated. For corpora where the addition of new data occurs under known, controlled circumstances, re-indexing can be done on the fly as new data are added, ensuring that the index database remains up to date. For large, uncontrolled corpora such as the World Wide Web, the index for any search engine will never be up to date in real time. Crawler codes, which are software agents that search continually for changes and additions to the corpora, then become the tool for updating the index database. Indeed, by some estimates, no more than 10% to 30% of the pages on the World Wide Web are accounted for by even the best search engines.

3.2—Weighting and Matching for Ranked Retrieval.

The basic retrieval function of an Internet search engine is initiated by a user query, which consists of one or more keywords that may be combined into a Boolean expression. The search engine first identifies the list of documents pointed to by the keywords, then prunes documents from the list that do not match the Boolean constraints imposed by the user. The remaining documents on the list are then sorted according to an a priori estimate of their relevance, and the sorted list of document URLs, often with a brief excerpt of phrases within each document containing the keywords, is returned to the user.

There exist numerous options for specifying the a priori estimates of relevance that determine the initial ranking of documents in the response to a query. Some approaches weight document relevance based upon the frequency of occurrence of a keyword in the document (on the assumption that more occurrences indicate greater relevance), while others include an additional factor of inverse document frequency, which weights the relevance of keywords in a multi-keyword query in inverse proportion to the number of documents in which they occur (on the assumption that fewer occurrences of a keyword within a document may imply greater specificity). Still other factors may be included that involve vector space similarity measures in the binary coincidence space between keywords and documents. Given that linguistic spaces themselves are not vector spaces, all such measures are ad hoc constructs, but nevertheless useful.

Many other measures besides those related to keywords are used in document relevance weighting. One common approach is to weight the relevance of a document by the number of other documents that link to it, on the assumption that more incoming links indicate a more authoritative document. Conversely, if a document were of interest for its survey value, a large number of outgoing links would induce a higher weight. Other factors may be included in the relevance weighting, such as the number of times a particular page has been visited, or indicators of previous relevance judgments by earlier users. More pecuniary search engine operators may even increase document relevance weightings in return for payment.

3.3—User Relevance Feedback.

The final function of a search engine is to incorporate relevance assessments by the user to refine, and hopefully to improve, the retrieval and ranking of documents resulting from subsequent queries. The simplest and most common example involves a user modifying her query based upon her assessment of a given retrieved set of documents, something web surfers do routinely.

Queries can be refined in more elaborate fashion by adjusting the query in the binary coincidence vector space described above toward the direction of one or more documents indicated as relevant by the user. This is equivalent to creating new keywords out of linear combinations of existing keywords. Note that this adjustment generally will alter the relatively sparse coincidence matrix between the original query and the keyword database, resulting in a higher dimensional query vector, with a corresponding increase in computational burden for retrieval.

Alternatively, the vector of keyword coincidences for a document can be adjusted toward a query for which it is deemed relevant, which will cause it to have a higher weight for future, similar queries by other users.

The most common measures of retrieval success are recall, defined as the fraction of relevant documents retrieved to the total number relevant in the data corpora, and precision, defined as the fraction of documents retrieved that are relevant. These two parameters typically exhibit a receiver operating characteristic type of inverse relationship: the higher the recall, the lower the precision, and vice versa. By recalling all documents from the corpora searched, we can achieve the maximum recall value of unity, but the precision will be no more than the fraction of relevant documents, which is typically a number near zero. On the other hand, the more precision we insist upon in retrieval, the greater the likelihood of excluding potentially relevant documents, thus decreasing the recall value.

4.0—Non-text Searching.

The conceptual approach to non-textual data domains is analogous to that described above in connection with textual data domains, but without the benefit of a linguistic framework. For ease of explanation, the following description utilizes equivalences between data types in textual and non-textual domains.

4.1—Data Equivalences.

Table 2 illustrates data equivalences defined herein. In the textual domain, a data corpus (or corpora) represents the totality of all data to be searched. Each element of the corpus is a document, which can be a file, a web page, or the like. From these documents, keywords are extracted and used to construct the index database.

TABLE 2
Data Equivalences Between Text and Non-Text Data

| TEXTUAL DATA | NON-TEXTUAL DATA |
|---|---|
| corpus | data source |
| document | data event |
| keyword | keytroid |

In the non-textual domain, the analog to a corpus is a data source, which may be a sensor output, a database of business or government records, a market data feed, or the like. This data source typically inputs new data into the database as time moves along. The data themselves are organized in some record format. For sensor data sources, this may be synchronous blocks of time series samples or pixels in an image. For business or government records, it will be entries in data fields of a specified format. For market data feeds, it will typically be an asynchronous time series with multiple entries (e.g., price and size of trades or quotes).

The equivalent of a document is a data event, which corresponds to a logical grouping of, for example, time samples into a temporal processing interval, or in the case of spatial pixels, into an image or image segment. In the case of record databases, this partitioning can be performed along any appropriate dimensions. If desired, “noise events,” i.e., data events that contain no information of interest, can be discarded by considering only data events that exceed a processing threshold or survive some filtering operation. In practical embodiments, the system retains the full set of data that is potentially of interest for searching.

The term “keytroids” represents the analog of keywords; a keytroid is a lexical-level information entity. In the preferred embodiment, keytroids represent the centroids of data event clusters, or more generally, of clusters within a corresponding attribute space (described in more detail below). The following description elaborates on the method of constructing these keytroids.

4.2—Non-Text Index Construction.

The fundamental problem in searching non-textual data is that the data do not “live” in a linguistic space from which one can directly extract a keyword database which serves as a relatively static, searchable database. Instead, the non-textual data merely represents a vast realm of numbers. Before one can build a search engine, one must identify semantically appropriate attributes of the data, which will serve as the space over which searches are conducted. These attributes should be at a primitive semantic level (e.g., having a semantically significant level above a symbolic level), so that they are easily calculated directly from the data. The number of attributes should be adequate to span the semantic ranges of features of interest within the data. In this regard, the number and types of attributes will vary depending upon the contextual meaning and application of the data.

The logical approach to characterizing numerical data values in the form of familiar linguistic terms is through the use of fuzzy sets. A fuzzy set includes a semantic label descriptor (e.g., long, heavy, etc.) and a set membership function, which maps a particular attribute value to a “degree of membership” in the fuzzy set. Set membership functions are context dependent, but for a given data domain, this context often can be normalized appropriate to the domain. For example, the actual values of time series samples that may contain a signal mixed with background noise can be normalized with respect to the average local noise level, which allows the assignment of meaning to the term “large amplitude” samples within a particular domain.

More generally, “conceptual fuzzy sets” may be employed as a means of capturing conceptual dependencies among fuzzy variables, which in effect amounts to an adaptive scaling of set membership functions based upon the conceptual context. For example, the term “big” has different scales, depending upon whether the domain of interest is automobiles or airplanes. The following description focuses upon domains where statically scaled fuzzy membership functions can be defined (or synthesized using supervised learning techniques), however, this is not a limitation of the general approach.

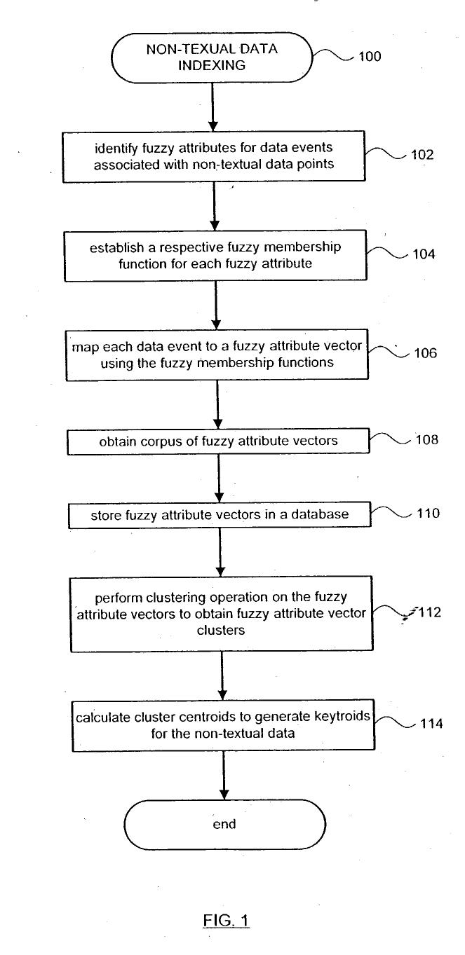

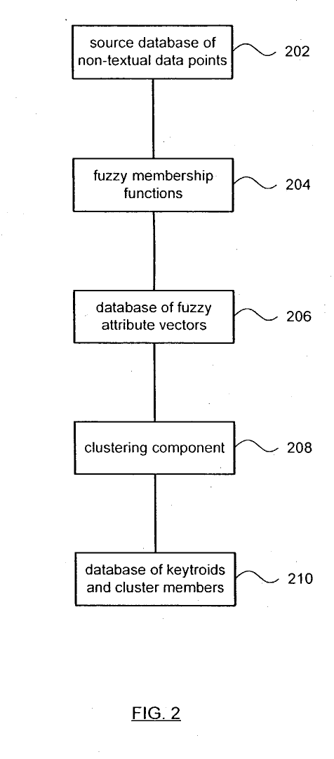

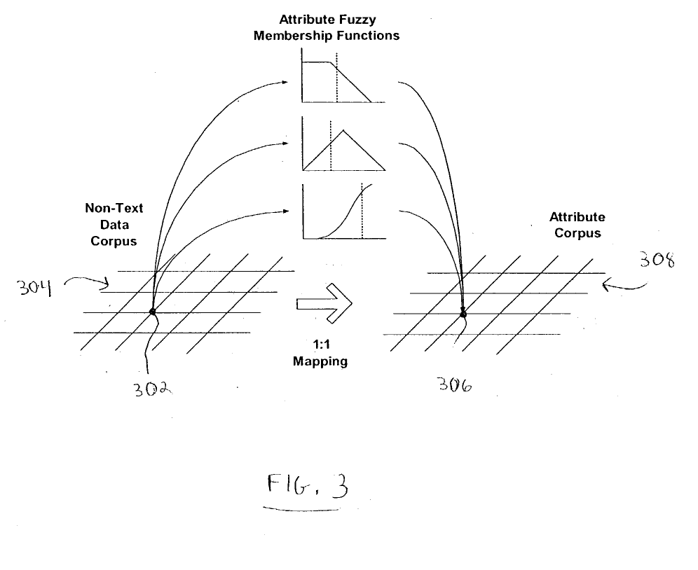

FIG. 1 is a flow diagram of a non-textual data indexing process 100 that can be performed to initialize a non-textual data search system. Some or all of process 100 may be performed by the system or by processing modules of the system. In this regard, FIG. 2 is a schematic representation of example system components or processing modules that may be utilized to support process 100. For the simplified example described herein, we assume that the raw non-textual data points represent a single data domain and that such data points are stored in a suitable source database 202 (see FIG. 2). Source database 202 need not be “integrated” or otherwise affiliated with the physical hardware that embodies the non-textual data search system. In other words, source database 202 may be remotely accessed by the non-textual data search system.

As an initial procedure, the non-textual data indexing process 100 identifies a number of fuzzy attributes for data events, where each data event is associated with one or more of the non-textual data points (task 102 of FIG. 1). The fuzzy attributes are characterized by a semantically significant level that is above the fundamental symbolic level, i.e., each fuzzy attribute has either a “lexical,” “syntactic,” or “semantic” meaning associated therewith. In accordance with the example embodiment, each of the data events has n fuzzy attributes, and the identification of the fuzzy attributes is based upon the contextual meaning of the data events (i.e., the specific fuzzy attributes of the non-textual data depend upon factors such as: the real world significance of the data and the desired searchable traits and characteristics of the data events).

A fuzzy membership function is established (task 104) or otherwise obtained for each of the fuzzy attributes identified in task 102. A given fuzzy membership function assigns a fuzzy membership value between 0 and 1 for the given data event. These fuzzy membership functions, which are also application and context specific, may be stored in a suitable database or memory location 204 accessible by the non-textual data search system. Task 102 and task 104 may be performed with human intervention if necessary.

Non-textual data indexing process 100 performs a task 106 to map each data event to a fuzzy attribute vector using the fuzzy membership functions. In this manner, process 100 obtains a corpus of fuzzy attribute vectors (task 108) corresponding to the non-textual data. Each fuzzy attribute vector is a set of fuzzy attribute values for the collection of non-textual data. In connection with a task 110, the resulting fuzzy attribute vectors can be stored or otherwise maintained in a suitably configured database 206 (see FIG. 2) that is accessible by the non-textual data search system. Regarding the mapping procedure, for a particular vector data value xₖ in the original data event database, we have a corresponding attribute vector yₖ whose elements yₖᵢ represent the set membership values of xₖ with respect to the i-th attribute, defined by the set membership functions

yₖᵢ(X)=mᵢ(Xₖ),i=1 . . . n (2)

Thus for each multidimensional entry in the original database, we create a corresponding multidimensional entry in the attribute database 206, representing the respective degrees of membership of the data entry in the various attribute dimensions. In the preferred embodiment, each fuzzy attribute vector corresponds to a non-textual data event, and each fuzzy attribute vector identifies fuzzy membership values for a number of fuzzy attributes of the respective non-textual data event.

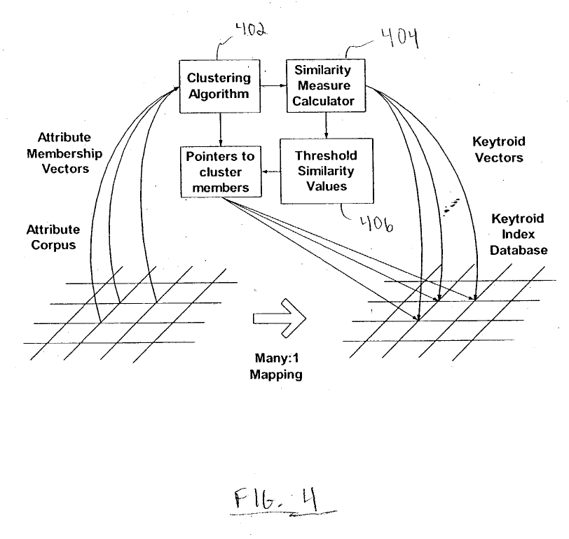

Note that all attribute vectors yₖ reside in the unit hypercube Iⁿ, where n is the number of attributes. This operation is illustrated in FIG. 3. FIG. 3 depicts a sample vector data value 302 as a point in the non-textual data corpus 304, and a corresponding attribute vector 306 as a point in the attribute corpus 308. In this simplified example, data value 302 has three attributes assigned thereto, each having a respective fuzzy membership function that maps data value 302 to its corresponding attribute vector 306.

Given the collection of attribute vectors yₖ, process 100 groups similar fuzzy attribute vectors from the corpus to form a plurality of fuzzy attribute vector clusters. In accordance with one practical embodiment, process 100 performs a suitable clustering operation on the fuzzy attribute vectors to obtain the fuzzy attribute vector clusters (task 112). In this regard, the non-textual data search system may include a suitably configured clustering component or module 208 that carries out one or more clustering algorithms. In the preferred embodiment, process 100 performs a standard adaptive vector quantizer (“AVQ”) clustering operation to calculate cluster centroids (task 114) and corresponding cluster members, where the number of clusters can be fixed or variable. The cluster centroids y^{(j)} we denote as attribute “keytroids,” since they will have a similar role to keywords in textual corpora. In lieu of the cluster centroid, process 100 may compute any identifiable or descriptive cluster feature to represent the keytroid, such as the center of the smallest hyperellipse that contains all of the cluster points. In practice, process 100 results in one or more databases that contain the keytroids and the cluster members (i.e., the fuzzy attribute vectors) associated with each keytroid. In this regard, a keytroid database 210 is shown in FIG. 2.

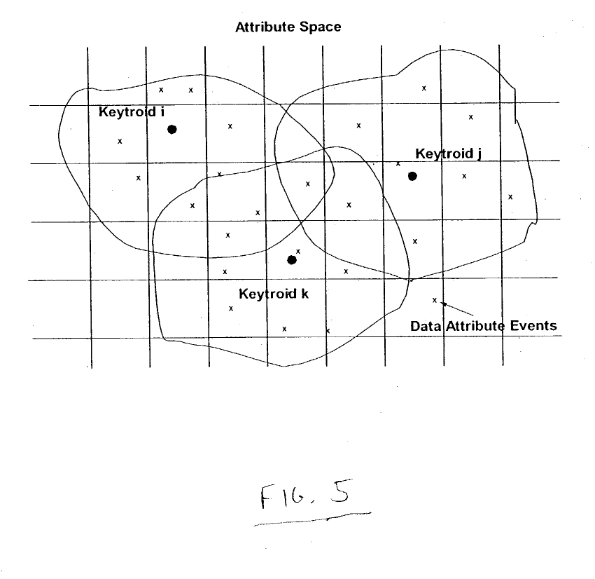

FIG. 4 is a diagram that illustrates the construction of a keytroid index database. As described above, a clustering algorithm 402 calculates keytroids corresponding to groups of fuzzy attribute vectors. The attribute vectors are represented by the grid on the left side of FIG. 4, while the keytroids are represented by the grid on the right side of FIG. 4. In the example embodiment, each keytroid is indicative of a number of fuzzy attribute vectors in the attribute vector corpus, and each fuzzy attribute vector is indicative of a data event corresponding to one or more non-textual data points in the source database 202. In the case where each data event has n fuzzy attributes, each keytroid specifies n fuzzy attributes. Thus, each cluster member yₗ^{(j)} has an associated pointer back to its corresponding original database entry, as illustrated in FIG. 3.

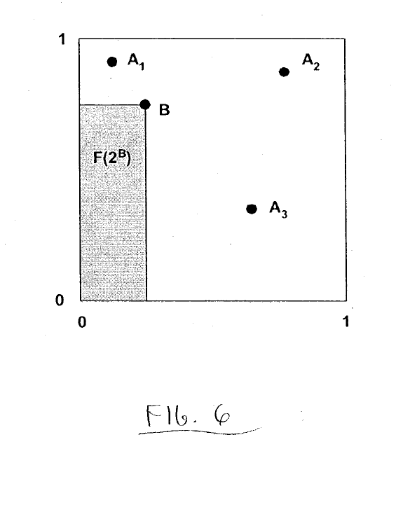

After the initial cluster formation, we can expand clusters to permit a given cluster member to belong to more than one cluster, should its similarity with respect to other keytroids exceed a threshold value. In this regard, FIG. 4 depicts a similarity measure calculator 404, which is configured to compare the keytroids, and one or more threshold similarity values 406, which are used to determine whether a given keytroid should belong to a particular cluster. FIG. 5 is a diagram that graphically depicts the manner in which “overlapping” clusters can share cluster members. For simplicity, FIG. 5 depicts the clusters as being two-dimensional elements. FIG. 5 also shows the keytroids for each cluster, where each keytroid represents the centroid of the respective cluster.

Thus at this point, we have transformed the original, numerical data entries, which represent lower levels of information, into attribute-space entries that represent semantic information via their degrees of membership in the various attribute classes, and have further extracted a set of keytroids y^{(j)} that partition the attribute space into clusters having similar attribute values. The set of keytroids form a lower dimensional index database for the attribute database, which will enable searching for entries having similar attributes.

The final operation needed for searching is a specific measure for the degree of similarity between a keytroid and an entry in the attribute database, particularly an entry that falls within its corresponding cluster. The AVQ algorithm used to perform the clustering operation above should employ the same measure. Most clustering algorithms employ a Mahalanobis distance metric, but this is not necessarily the best measure for use in spaces that are confined to the unit hypercube. There are numerous ad hoc measures that could serve this function, but we will suggest a more fundamentally justified measure, denoted as mutual subsethood. In the next section, we present the mathematical background for this measure.

5.0—Review of Fuzzy Systems.

As mentioned previously, a fuzzy set is composed of a semantically descriptive label and a corresponding set membership function. Kosko has developed a geometric perspective of fuzzy sets as points in the unit hypercube Iⁿ that leads immediately to some of the basic properties and theorems that form the mathematical framework of fuzzy systems theory. While a number of polemics have been exchanged between the camps of probabilists and fuzzy systems advocates, we consider these domains to be mutually supportive, as will be described below.

5.1—Fuzzy Sets as Points.

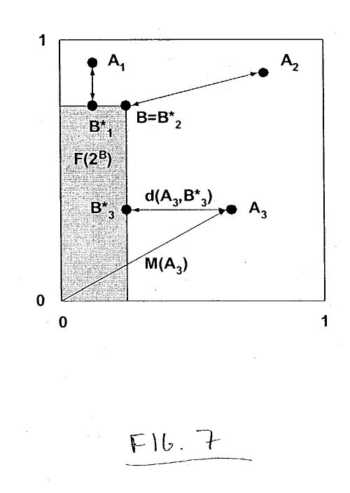

A fuzzy set is the range value of a multidimensional mapping from an input space of variables, generally residing in R^{m}, into a point in the unit hypercube Iⁿ. FIG. 6 illustrates a two-dimensional fuzzy cube and some fuzzy sets lying therein. A given fuzzy set B has a corresponding fuzzy power set F(2^{B}) (i.e., the set of all sets contained within itself), which is the hyper rectangle snug against the origin whose outermost vertex is B, as shown in the shaded area of FIG. 6. All points y lying within F(2^{B}) are subsets of B in the conventional sense that

mᵢ(y)≦mᵢ(B), for all i (3)

However, we can extend this notion of subsethood further, to include fuzzy sets that are not proper subsets of one another.

5.2—Subsethood.

Every fuzzy set is a fuzzy subset (i.e., to a quantifiable degree) of every other fuzzy set. The basic measure of the degree to which fuzzy set A is a subset of fuzzy set B is fuzzy subsethood, defined by:

$$S ( A , B ) = 1 - \frac{d ( A , {B}^{*} )}{M ( A )} \qquad ( 4 )$$

where d(A, B*) is the Hamming distance between A and B*, the latter being nearest point to A contained within F(2^{B}), and M(A) is the Hamming norm of fuzzy set A:

$$M ( A ) = {\sum }_{i = 1}^{n} {m}_{A} ( {y}_{i} ) \qquad ( 5 )$$

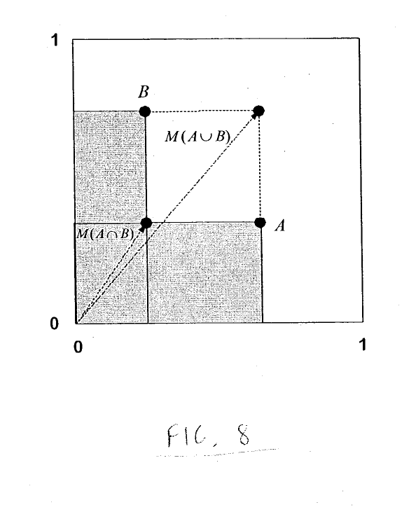

FIG. 7 illustrates these components of fuzzy subsethood.

For example, if fuzzy set A has components

$$\{ \frac{5}{8} , \frac{3}{8} \}$$

and B has components

$$\{ \frac{1}{4} , \frac{3}{4} \} ,$$

then

$$d ( A , {B}^{*} ) = \frac{3}{8} ,$$

and

$$M ( A ) = 1 , so S ( A , B ) = \frac{5}{8} .$$

Note that fuzzy subsethood in general is not symmetric, i.e., S(A, B) ≠S(B, A).

The fundamental significance of subsethood derives from the subsethood theorem:

$$S ( A , B ) = \frac{M ( A ⋂ B )}{M ( A )} , \qquad ( 6 )$$

where the intersection operator invokes the conventional minimum operation, i.e.,

A∩B=A*=B={yᵢ:yᵢ=min(aᵢ,bᵢ)} (7)

This theorem leads immediately to the Bayesian-like identity

$$S ( A , B ) = \frac{S ( B , A ) M ( B )}{M ( A )} . \qquad ( 8 )$$

It is here that the relationship between fuzzy theory and probability theory becomes apparent. Let X be the point {1, . . . ,1} in Iⁿ, i.e., the outer vertex of the unit hypercube, and let aᵢ be the binary indicator function of an event outcome in the i-th trial of a random experiment (e.g., the event of heads in an arbitrarily biased coin toss) repeated n times. Then X represents the “universe of discourse” (i.e., the set of all possible outcomes) for the entire experiment, and

$$S ( X , A ) = \frac{M ( A ⋂ X )}{M ( X )} = \frac{M ( A )}{M ( X )} = \frac{{n}_{A}}{n} , \qquad ( 9 )$$

where n_{A} denotes the number of successful outcomes of the event in question. In other words, the subsethood of the universe of discourse in one of its binary component subsets (corresponding to one of the other vertices of the unit hypercube) is simply the relative frequency of occurrence of the event in question. Thus, probability (in either Bayesian or relative frequency interpretations) is directly related to subsethood.

The above illustrates the “counting” aspect of fuzzy subsethood when applied to crisp outcomes, which also is central to probability theory (the Borel field over which a probability space is defined is by definition a sigma-field, and thus countable). However, note that equation (4) includes a “partial count” term in both the numerator and denominator when the fuzzy sets in question do not reside at a vertex of Iⁿ, which implies that subsethood is more general than conditional probability. Nevertheless, we avoid involvement in this debate and simply state the equivalences that subsethood (conditional probability) measures the degree to which the attributes (outcomes) of A are specified, given the attributes (outcomes) of B.

5.3—Mutual Subsethood.

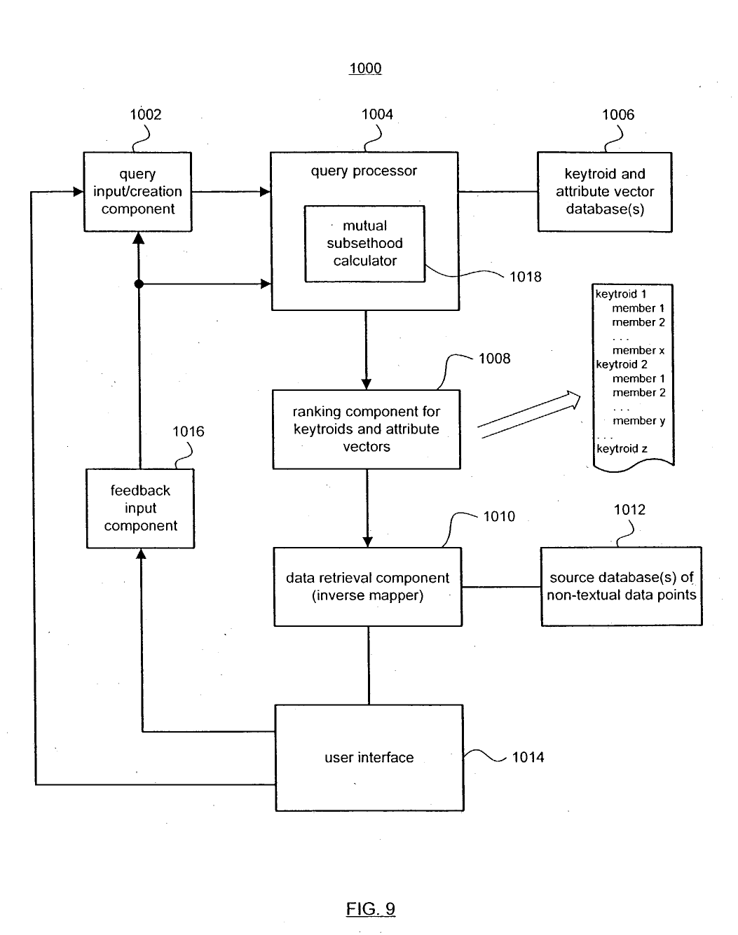

Subsethood measures the degree to which fuzzy set A is a subset of B, which is a containment measure. For index matching and retrieval, we need a measure of the degree to which fuzzy set A is similar to B, which can be viewed as the degree to which A is a subset of B, and B is a subset of A. For this obviously symmetric relationship, we use the mutual subsethood measure:

$$E ( A , B ) = \frac{M ( A ⋂ B )}{M ( A ⋃ B )} ( 0 \leq E ( A , B ) \leq 1 ) , \qquad ( 10 )$$

where the union operator invokes the component wise maximum operation. Note that

$$E ( A , B ) = \{ \begin{matrix}1 , iff A = B \\ 0 , if A or B = Φ\end{matrix} \qquad ( 11 )$$

where Φ denotes the null fuzzy set at the origin of Iⁿ. FIG. 8 illustrates mutual subsethood geometrically as the ratio of the Hamming norms (not the Euclidean norms) of two fuzzy sets derived from A and B. Mutual subsethood is the fundamental similarity measure we will use in index matching and retrieval for searching non-textual data corpora.

As a final generalization, we note that the mutual subsethood measure can incorporate dimensional importance weighting in straightforward fashion. Let wᵢ,i=1 . . . n, wᵢ>0 be a set of importance weights for the various attribute dimensions, where typically

$${\sum }_{i = 1}^{n} {w}_{i} = 1. \qquad ( 12 )$$

Then we define the generalized mutual subsethood E_{w}(A, B), with respect to the weight vector w, by

$${E}_{w} ( A , B ) {Δ}_{\underline{\_}} \frac{{M}_{w} ( A ⋂ B )}{{M}_{w} ( A ⋃ B )} {Δ}_{\underline{\_}} \frac{{\sum }_{i = 1}^{n} {w}_{i} min ( {a}_{i} , {b}_{i} )}{{\sum }_{i = 1}^{n} {w}_{i} max ( {a}_{i} , {b}_{i} )} = \frac{{w}^{T} ( A ⋂ B )}{{w}^{T} ( A ⋃ B )} . \qquad ( 13 )$$

Note that E_{w}(A,B) satisfies the same properties in equation (11) as does E(A, B). The weight vector w can be calculated, for example, using pairwise importance comparisons via the analytic hierarchy process (“AHP”).

6.0—Non-textual Data Query and Retrieval.

In accordance with the preferred embodiment, mutual subsethood provides the distance measure, not only for index keytroid cluster formation, but also for processing queries for information retrieval. In practice, the two basic operations performed by the non-textual data search system are query formulation and retrieval processing, as described in more detail below.

6.1—Query Formulation.

Non-textual queries are formulated in the dimensions of the attribute space Iⁿ. A query in this space specifies a set of desired fuzzy attribute set membership values (i.e., a fuzzy set), for which data events having similar fuzzy set attribute values are sought. In the practical embodiment where each data event has n designated fuzzy attributes, a query vector can specify up to n fuzzy attributes. Thus, a particular query may represent a point in Iⁿ.

A number of options exist for constructing query vectors. In some applications, it may be convenient and appropriate to construct these vectors directly in the attribute space Iⁿ. In other applications, it may be desirable to build a linguistic and/or graphical user interface, where the query is created in the linguistic/graphical domain and then translated into a representative fuzzy set in Iⁿ. We can go further by calculating relative attribute importance weights for use in the query, using, e.g., the analytic hierarchy process as mentioned in the previous section.

6.2—Retrieval Processing.

The task in retrieval processing is to match the query vector against the keytroid index vectors. As is the case for the query vector, each keytroid vector in the index database represents a point in Iⁿ. Each query/keytroid pair thus consists of two fuzzy sets in Iⁿ, each of which is a fuzzy subset of the other. In other words, the query vector is a fuzzy subset of each keytroid in the keytroid database, and each keytroid in the keytroid database is a fuzzy subset of the query vector. The query fuzzy set is compared pairwise against each keytroid fuzzy set, preferably using the mutual subsethood measure as the matching score.

The results of these comparisons are ranked in order of mutual subsethood score, and can be thresholded to eliminate keytroids that are too low scoring to be considered relevant. For each ranked keytroid, the mutual subsethood scores of its corresponding cluster members rank the keytroid cluster members. Mapping these cluster members back to the original database results in a ranked retrieval list of data events that satisfy the query to the highest degrees of mutual subsethood. This list can be displayed to an operator/analyst at each stage of retrieval, much as in a conventional textual search engine.

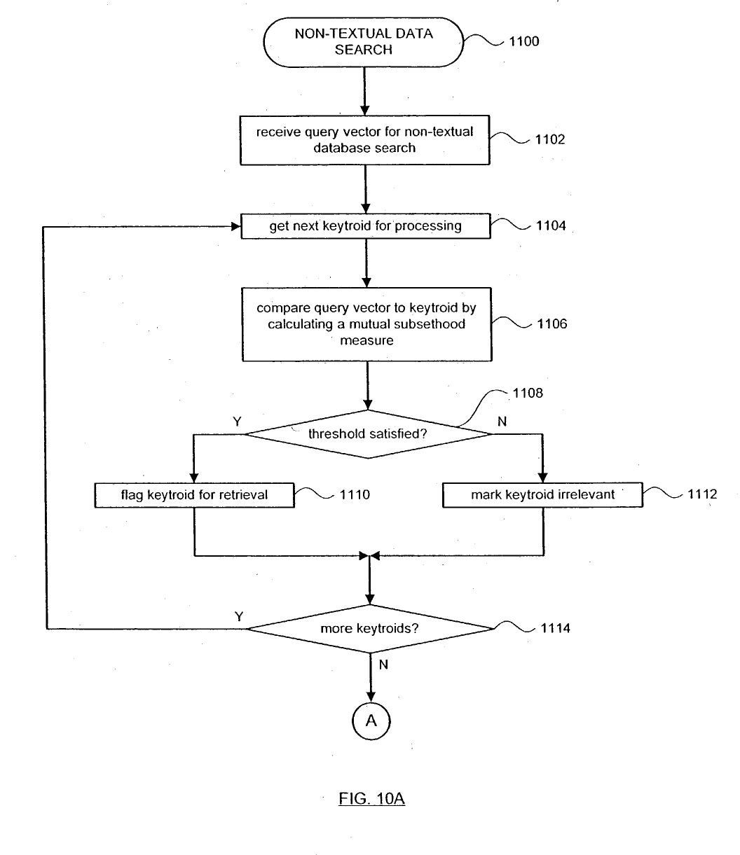

FIG. 9 is a schematic representation of an example non-textual data search system 1000 that may be employed to carry out the searching techniques described herein. System 1000 generally includes a query input/creation component 1002, a query processor 1004, at least one database 1006 for keytroids and fuzzy attribute vectors, a ranking component 1008, a data retrieval component 1010, at least one source database 1012, a user interface 1014 (which may include one or more data input devices such as a keyboard or a mouse, a display monitor, a printing or other output device, or the like), and a feedback input component 1016. A practical system may include any number of additional or alternative components or elements configured to perform the functions described herein; system 1000 (and its components) represents merely one simplified example of a working embodiment.

Query input/creation component 1002 is suitably configured to receive a query vector specifying a searching set of fuzzy attribute values for the given collection or corpus of non-textual data. In one embodiment, component 1002 receives the query vector in response to user interaction with user interface 1014. Alternatively (or additionally), query input/creation component 1002 can be configured to automatically generate a suitable query vector in response to activities related to another system or application (e.g., the system or application that generates and/or processes the non-textual data). A suitable query can also be generated “by example,” where a known data point is selected by a human or a computer, and the query is generated based on the attributes of the known data point.

Query input/creation component 1002 provides the query vector to query processor 1004, which processes the query vector to match a subset of keytroids from keytroid database 1006 with the query vector. In this regard, query processor 1004 may compare the query vector to each keytroid in database 1006. As described in more detail below, query processor 1004 preferably includes or otherwise cooperates with a mutual subsethood calculator 1018 that computes mutual subsethood measures between the query vector and each keytroid in database 1006. Query processor 1004 is generally configured to identify a subset of keytroids (and the respective cluster members) that satisfy certain matching criteria.

Ranking component 1008 is suitably configured to rank the matching keytroids based upon their relevance to the query vector. In addition, ranking component 1008 can be configured to rank the respective fuzzy attribute vectors or cluster members corresponding to each keytroid. Such ranking enables the non-textual data search system to organize the search results for the user. FIG. 9 depicts one way in which the keytroids and cluster members can be ranked by ranking component 1008.

Data retrieval component 1010 functions as a “reverse mapper” to retrieve at least one data event corresponding to at least one of the ranked keytroids. Component 1010 may operate in response to user input or it may automatically retrieve the data event and/or the associated non-textual data points. As depicted in FIG. 9, data retrieval component 1010 retrieves the data from source database 1012. The data events and/or the raw non-textual data may be presented to the user via user interface 1014.

Feedback input component 1016 may be employed to gather relevance feedback information for the retrieved data and to provide such feedback information to query processor 1004. The relevance feedback information may be generated by a human operator after reviewing the search results. In accordance with one practical embodiment, query processor 1004 utilizes the relevance feedback information to modify the manner in which queries are matched with keytroids. Thus, the search system can leverage user feedback to improve the quality of subsequent searches. Alternatively, the user can provide relevance feedback in the form of new or modified search queries.

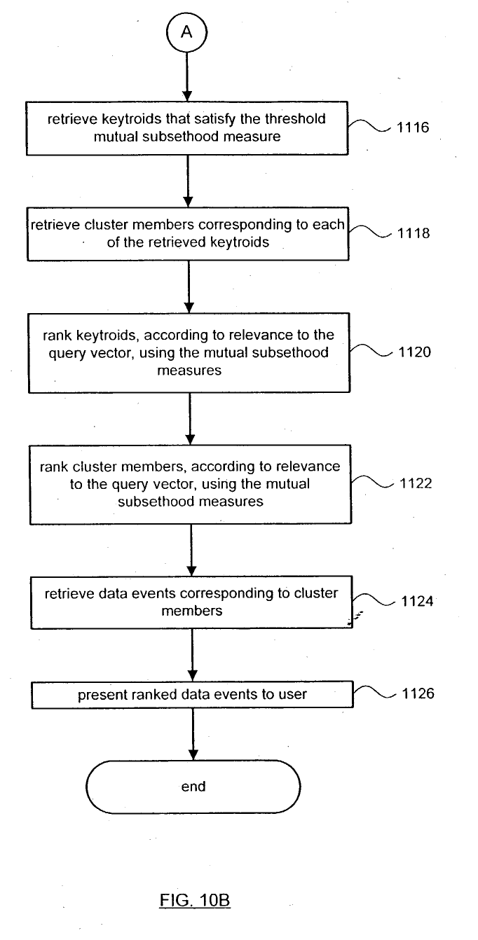

FIG. 10 is a flow diagram of an example non-textual data search process 1100 that may be performed in the context of a practical embodiment. Process 1100 begins upon receipt of a query vector that is suitably formatted for searching of a non-textual database (task 1102). As mentioned previously, the query specifies non-textual attributes at a semantically significant level above a symbolic level, and the search system compares the query to keytroids that represent groupings of fuzzy attribute vectors for the non-textual data. In the preferred embodiment, process 1100 compares the query vector to each keytroid for the particular domain of non-textual data. Accordingly, process 1100 gets the next keytroid for processing (task 1104) and compares the query vector to that keytroid by calculating a similarity measure, e.g., a mutual subsethood measure (task 1106).

If the current mutual subsethood measure satisfies a specified threshold value (query task 1108), then the keytroid is flagged or identified for retrieval (task 1110). Otherwise, the keytroid is marked or identified as being irrelevant for purposes of the current search (task 1112). If more keytroids remain (query task 1114), then process 1100 is re-entered at task 1104 so that each of the keytroids is compared against the query vector. In a practical embodiment, the keytroid matching procedure may be performed in parallel rather than in sequence as depicted in FIG. 10. The threshold mutual subsethood measure represents a matching criteria for obtaining a subset of keytroids from the keytroid database, where the subset of keytroids “match” the given query vector. If all of the keytroids have been processed, then query task 1114 leads to a task 1116, which retrieves those keytroids that satisfy the threshold mutual subsethood measure. The keytroids are retrieved from the keytroid database.

In addition, process 1100 preferably retrieves the cluster members (i.e., the fuzzy attribute vectors) corresponding to each of the retrieved keytroids (task 1118). As described above, the cluster members may also be retrieved from a database accessible by the search system. The retrieved keytroids can be ranked according to relevance to the query vector, using their respective mutual subsethood measures as a ranking metric (task 1120). The retrieved cluster members can also be ranked according to relevance to the query vector, using their respective mutual subsethood measures as a ranking metric (task 1122).

As described above, each cluster member can be mapped to a data event associated with one or more non-textual data points. Accordingly, process 1100 eventually retrieves the data events corresponding to the retrieved cluster members (task 1124). If desired, the ranked data events are presented to the user in a suitable format (task 1126), e.g., visual display, printed document, or the like.

7.0—Relevance Feedback.

The final stage of basic search engine functionality is that of relevance feedback from the human in the loop to the search engine. There are numerous approaches that have been proposed for incorporating such feedback in textual search engines, many of them dependent upon the linguistic framework and other structural aspects of textual corpora. For non-textual applications, we propose to use this feedback in a connectionist, reinforcement learning architecture iteratively to improve the search results based upon human evaluations of a subset of the results returned at each stage, analogous to the Adaptive Information Retrieval system utilized for textual data.

7.1—Connectionist Architecture.

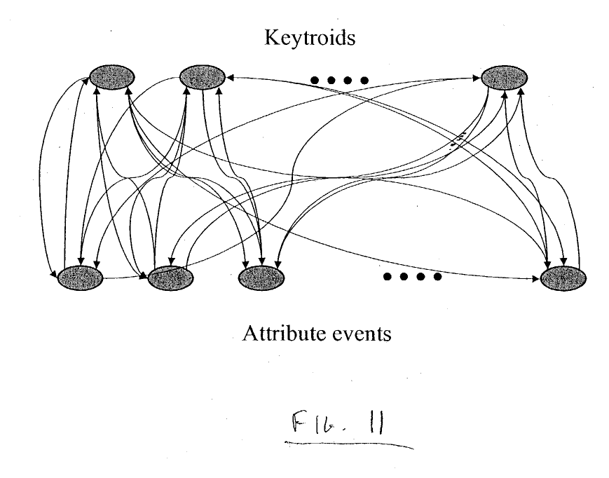

As previously described, the non-textual indexing operation creates a keytroid index database, along with the pointers to attribute event database cluster members (and their corresponding data events in the original database) that are associated with each keytroid. In addition, a given attribute event can be associated with multiple keytroids, provided that its mutual subsethood with respect to a particular keytroid exceeds a threshold value. This suggests a connectionist type architecture between keytroids and attribute events, wherein the connection weights are initialized using the mutual subsethood scores between keytroids and attributes. FIG. 11 depicts this architecture in its most general form, wherein each keytroid has a link to each attribute event. In practice, we would typically limit the links to keytroid/attribute event pairs whose mutual subsethood exceeds a threshold value, resulting in a much more sparsely populated connection matrix.

The initial link weights are assigned their corresponding mutual subsethood values, which were calculated in the indexing and keytroid clustering process. However, for dynamical stability, it is desirable to normalize the outgoing link weights for each node in the network to unity. This is accomplished by dividing each outgoing link weight for each node by the sum of all outgoing link weights for that node. Once this is done, we have an initial condition for the connectionist architecture that captures our a priori knowledge of the relationships between keytroids and attribute events, as specified by the original indexing and keytroid clustering processes.

Now suppose that a user formulates an initial query in the form of a fuzzy set point in Iⁿ, as described in the previous section. This query is used to “ping” the keytroid nodes in the connectionist architecture with a set of activations equal to the (thresholded) mutual subsethood values between the query and each keytroid.

In the first iteration, these activations propagate through the weighted links to activate a set of corresponding nodes in the attribute event layer. In typical neural network fashion, a sigmoid function (or other limiting function) is used to normalize the sum of the input activations to each attribute layer node. This first iteration thus generates a set of attribute events, along with their corresponding activations, which can be displayed graphically in a manner similar to FIG. 11, but using only the subset of initially activated nodes and their corresponding links. In one such embodiment, the nodes in each layer (keytroid and attribute) can be displayed so that those with the highest activation levels appear centered in their respective display layers, while those with successively lower activation levels are displayed further out to the sides of the graph. Also, the activation values propagated along each incoming link are indicated by the heaviness or thickness of the line depicting each link.

Thus at the conclusion of the first iteration, we already have a set of attribute events, ranked by activation level, for display to the user as the initial response to his query. However, the primary objective of using the connectionist architecture is to allow additional activations of other relevant nodes that may not have been directly activated by the initial query. Thus in the second iteration, we outwardly propagate the activations of attribute events through the existing links to activate other linked keytroids that were not involved in the initial query. As before, the activation level of each secondary keytroid node is the (thresholded) sigmoid-limited sum of products of the corresponding attribute layer node activations and the incoming link weights. The new keytroid nodes from this process are then added to the graphical display, along with their corresponding weighted links.

The above outwardly propagating activation process is allowed to iterate until no new nodes are added at a given stage, whereupon the final result is displayed to the user. Note however, that the iteration can be allowed to proceed stepwise under user control, so that intermediate stages are visible to the user, and the user if desired can inject new activations (see next section) or halt the iteration at any stage. At each stage, a current ranked list of retrieved data events can be displayed to the user.

Up to this point, all activation levels are positive, since the initial activations (mutual subsethood values) are positive, and the magnitude of the activation level is an indication of the degree of relevance of a keytroid and/or attribute event. In the next section, however, we allow for negative activation levels as a result of user feedback, which can be interpreted as degrees of irrelevance.

7.1—Reinforcement Learning.

The connectionist architecture and iterative scheme described thus far incorporates the user's initial query and our a priori knowledge of the links and weights between keytroid and attribute event nodes. To enable subsequent user intervention in the search process (which is equivalent to query refinement), we incorporate a reinforcement learning process, whereby at any stage of iteration, the user can halt the process and inject modified activations at either the keytroid or attribute event layer.

Using a mouse and graphical symbols, for example, the user can designate his choice of particular nodes as being very relevant, relevant, irrelevant, or very irrelevant. This results in adding or subtracting a corresponding input amount to the sigmoids whose outputs represent the current activation levels of those nodes, after which the iteration is allowed to resume using these new initial conditions. Normally, the user input would occur at the attribute event nodes, after the user has inspected and evaluated the corresponding data events for relevance or irrelevance. In this scheme, node activations can be either positive (indicating degrees of relevance) or negative (indicating degrees of irrelevance), in keeping with the general notion of user interactive searches being a learning process both for the search engine and the user.

Employing a local learning rule to adjust the link weight values away from their initial mutual subsethood values in a training phase (or via accumulation over time of normal user activity) can further extend this process. One such rule calculates new weights w_{i,j} for links between nodes whose activations have been modified by the user and their directly connected nodes, in proportion to the sample correlation coefficient:

$${w}_{i , j} ∝ \frac{{\sum }_{i = 1}^{N} {a}_{i} {r}_{j} - \frac{1}{N} {\sum }_{i = 1}^{N} {a}_{i} {\sum }_{j = 1}^{N} {r}_{j}}{\sqrt{{\sum }_{i = 1}^{N} {a}_{i}^{2} - \frac{1}{N} ( {\sum }_{i = 1}^{N} {a}_{i} )} \sqrt{{\sum }_{j = 1}^{N} {r}_{j}^{2} - \frac{1}{N} {( {\sum }_{j = 1}^{N} {r}_{j} )}^{2}}} \qquad ( 14 )$$

where rⱼ is the user-inserted activation signal described above (positive or negative) on the j-th node, aᵢ is the prior activation level of the i-th connected node, and N is the number of training instances (or past user interactions used for training) for this particular link. A strong positive (or negative) correlation between the inserted activations on a selected node and the prior activations of linked nodes will thus reinforce the weight strength between these nodes, while the lack of such correlation will decrease the weight strength.

Using these approaches, reinforcement learning within the connectionist architecture occurs both directly, via the modification of a subset of node activations at a selected stage of iteration in a particular search, and indirectly, via the modification of node link weights over multiple searches.

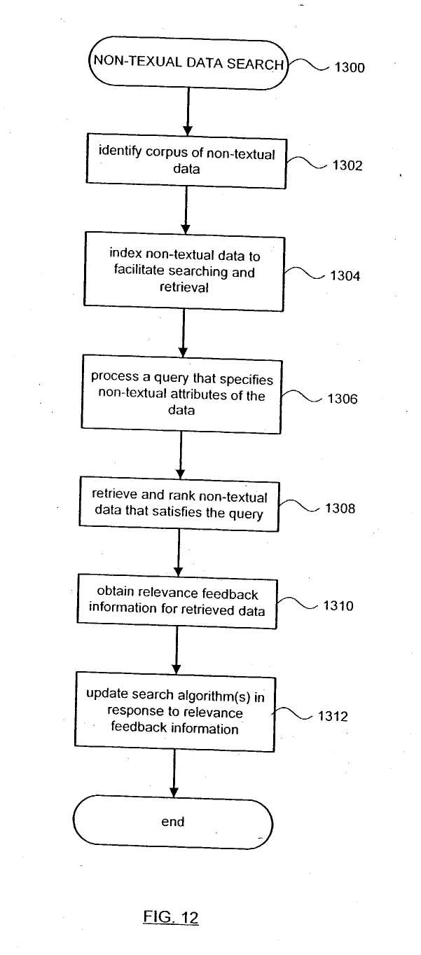

The following is a brief summary of the overall non-textual data searching methodology described herein. FIG. 12 is a flow diagram of a non-textual data search process 1300 that represents this overall approach. The details associated with this approach have been previously described herein.

Initially, the specific corpus of non-textual data is identified (task 1302) and indexed at a semantically significant level above a symbolic level to facilitate searching and retrieval (task 1304). As a result of the indexing procedure, a number of keytroids (and a number of fuzzy attribute vectors corresponding to each keytroid) are obtained and stored in a suitable database. Once the non-textual data corpus is indexed, the search system can process a query that specifies non-textual attributes of the data (task 1306). As described above, the query is processed by evaluating its similarity with the keytroids and the attribute vectors. In response to the query processing, non-textual data (and/or data events associated with the data) that satisfies the query are retrieved and ranked (task 1308) according to their relevance or similarity to the query.

The search system may be configured to obtain relevance feedback information for the retrieved data (task 1310). The system can process the relevance feedback information to update the search algorithm(s), perform re-searching of the indexed non-textual data, modify the search query and conduct modified searches, or the like (task 1312). In this manner, the search system can modify itself to improve future performance.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A non-textual data search method comprising:
receiving a query vector specifying a searching set of fuzzy attribute values for a collection of non-textual data;
matching a subset of keytroids from a keytroid database with said query vector, each keytroid in said keytroid database specifying a respective set of fuzzy attribute values for said collection of non-textual data; and
retrieving at least one data event corresponding to each keytroid in said subset of keytroids, each data event being associated with one or more non-textual data points from said collection of non-textual data.

2. A method according to claim 1, wherein each keytroid in said keytroid database identifies a respective cluster of fuzzy attribute vectors.

3. A method according to claim 2, wherein each of said fuzzy attribute vectors is a set of fuzzy attribute values for said collection of non-textual data.

4. A method according to claim 1, further comprising ranking said subset of keytroids based upon relevance to said query vector.

5. A method according to claim 1, further comprising ranking said at least one data event based upon relevance to said query vector.

6. A method according to claim 1, wherein:
each of said at least one data event has n fuzzy attributes;
said query vector specifies up to n fuzzy attributes; and
each keytroid in said keytroid database specifies n fuzzy attributes.

7. A method according to claim 1, wherein:
said query vector is a fuzzy subset of each keytroid in said keytroid database; and
each keytroid in said keytroid database is a fuzzy subset of said query vector.

8. A method according to claim 1, wherein said matching step compares said query vector to each keytroid in said keytroid database.

9. A method according to claim 1, wherein said matching step calculates similarity measures between said query vector and each keytroid in said keytroid database.

10. A method according to claim 1, wherein said matching step calculates mutual subsethood measures between said query vector and each keytroid in said keytroid database.

11. A method according to claim 10, further comprising ranking said subset of keytroids based upon said mutual subsethood measures.

12. A method according to claim 1, wherein:
each keytroid in said keytroid database identifies a respective cluster of fuzzy attribute vectors;
said matching step employs a connectionist algorithm to match said subset of keytroids with said query vector; and
said method further comprises:
obtaining relevance feedback information for said at least one data event; and
modifying said connectionist algorithm in response to said relevance feedback information.

13. A non-textual data search system comprising:
a query input component configured to receive a query vector specifying a searching set of fuzzy attribute values for a collection of non-textual data;
a keytroid database containing a number of keytroids, each specifying a respective set of fuzzy attribute values for said collection of non-textual data; and
a query processing component configured to match a subset of keytroids from said keytroid database with said query vector.

14. A system according to. Claim 13, further comprising a ranking component configured to rank said subset of keytroids based upon relevance to said query vector.

15. A system according to claim 13, further comprising a data retrieval component configured to retrieve at least one data event corresponding to at least one keytroid in said subset of keytroids, each data event being associated with one or more non-textual data points from said collection of non-textual data.

16. A system according to claim 15, further comprising a source database for storing said collection of non-textual data.

17. A system according to claim 15, wherein:
each of said at least one data event has n fuzzy attributes;
said query vector specifies up to n fuzzy attributes; and
each keytroid in said keytroid database specifies n fuzzy attributes.

18. A system according to claim 13, wherein each keytroid in said keytroid database identifies a respective cluster of fuzzy attribute vectors.

19. A system according to claim 18, wherein each of said fuzzy attribute vectors is a set of fuzzy attribute values for said collection of non-textual data.

20. A system according to claim 13, wherein:
said query vector is a fuzzy subset of each keytroid in said keytroid database; and
each keytroid in said keytroid database is a fuzzy subset of said query vector.

21. A system according to claim 13, wherein said query processing component compares said query vector to each keytroid in said keytroid database.

22. A system according to claim 13, wherein said query processing component calculates mutual subsethood measures between said query vector and each keytroid in said keytroid database.

23. A system according to claim 13, wherein:
each keytroid in said keytroid database identifies a respective cluster of fuzzy attribute vectors;
said query processing component employs a connectionist algorithm to match said subset of keytroids with said query vector; and
said system further comprises a feedback input component for obtaining relevance feedback information for said at least one data event; wherein
said query processing component is further configured to modify said connectionist algorithm in response to said relevance feedback information.

24. A computer program for searching non-textual data, said computer program being embodied on a computer-readable medium, said computer program having computer-executable instructions for carrying out a method comprising:
receiving a query vector specifying a searching set of fuzzy attribute values for a collection of non-textual data;
matching a subset of keytroids from a keytroid database with said query vector, each keytroid in said keytroid database specifying a respective set of fuzzy attribute values for said collection of non-textual data; and
retrieving at least one data event corresponding to at least one keytroid in said subset of keytroids, each data event being associated with one or more non-textual data points from said collection of non-textual data.

25. A non-textual data search method comprising:
indexing non-textual data at a semantically significant level above a symbolic level to obtain a database of indexed non-textual data;
processing a query specifying non-textual attributes at a semantically significant level above a symbolic level; and
retrieving, from said database and in response to said query, at least one data event associated with said indexed non-textual data.

26. A method according to claim 25, wherein indexing non-textual data comprises constructing a plurality of keytroids, each specifying a respective set of fuzzy attribute values for said indexed non-textual data.

27. A method according to claim 26, wherein:
said query is a query vector specifying a searching set of fuzzy attribute values for said indexed non-textual data; and
processing said query comprises matching a subset of said keytroids with said query vector.

28. A method according to claim 27, wherein:
said query vector is a fuzzy subset of each of said plurality of keytroids; and
each of said plurality of keytroids is a fuzzy subset of said query vector.

29. A method according to claim 25, further comprising ranking said at least one data event based upon relevance to said query.

30. A method according to claim 25, further comprising:
obtaining relevance feedback information for said at least one data event; and
re-searching said indexed non-textual data, at a semantically significant level above a symbolic level, in response to said relevance feedback information.
